(19) United States
(12) Patent Application Publication
(10) Pub. No.: US 2009/0079857 A1
(43) Pub. Date: Mar. 26, 2009

(54) SOLID-STATE IMAGING DEVICE, RECEIVED-LIGHT INTENSITY MEASURING DEVICE, AND RECEIVED-LIGHT INTENSITY MEASURING METHOD

(75) Inventors: Yoshihisa KATO, Shiga (JP); Takahiko MURATA, Osaka (JP); Shigetaka KASUGA, Osaka (JP); Takayoshi YAMADA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/235,839

(22) Filed: Sep. 23, 2008

(30) Foreign Application Priority Data
Sep. 26, 2007 (JP) 2007-249909

(51) Int. Cl. H04N 5/30; G01J 1/44

(52) U.S. Cl. 348/294; 356/218

(57) ABSTRACT

The received-light intensity measuring device includes: a pixel circuit 1 including a photodiode (PD) that accumulates an amount of electric charges according to the intensity of received light, a floating diffusion (FD) that generates a signal voltage V_{CL} according to an amount of retained electric charges, and a transfer switch that controls the transfer, to the FD, of the electric charges accumulated in the PD; a DAC 11 that generates a control voltage V_{TRAN} varying in a ramp waveform and applies V_{TRAN} to the gate of the transfer switch; a column AD conversion circuit 13 that obtains the digital value by quantizing a length of time from a first point in time set with reference to a period during which V_{TRAN} is applied to a second point in time at which a specific fluctuation occurs in a temporal variation rate of the signal voltage V_{CL} while V_{TRAN} is being applied.

### BACKGROUND OF THE INVENTION

(1) Field of the Invention

The present invention relates to a solid-state imaging device that incorporates an analog-digital conversion (AD-conversion) function and generates, through reception of light, a digital value according to electric charges accumulated in a photoelectric conversion element, a received-light intensity measuring device, and a received-light intensity measuring method.

(2) Description of the Related Art

Due to the development of digital technology, image signals obtained by solid-state imaging devices are digital-converted and signal-processed, or recorded as digital signals. The analog values of image signals generated by conventional solid-state imaging devices are converted into digital values by external AD converters. In recent years, with demands growing for downsizing and reduced power consumption of an apparatus incorporating a solid-state imaging device, the development of a solid-state imaging device incorporating an AD converter has become active (for example, see Japanese Unexamined Patent Application Publication No. 2006-033452 and Japanese Unexamined Patent Application Publication No. 2006-033453).

FIG. 1 shows the configuration of the main portion of a conventional solid-state imaging device incorporating AD converters.

In the solid-state imaging device shown in FIG. 1, pixel circuits 80 are arranged in a matrix, and a column signal line 81 and a row select line 82 are connected to each of the pixel circuits. The row select line 82 has one end connected to a vertical drive circuit 83 that generates a drive pulse to each pixel circuit in accordance with a vertical scanning signal generated by a vertical scanning circuit 84. In addition, the column signal line 81 has one end connected to a grounding line via a load resistor 85, and also to a sample hold (S/H) circuit 86.

An output from the S/H circuit 86 is connected to a comparator 87, along with an output 91 from a digital-analog converter (DAC) 90, and the output of the comparator 87 is connected to a counter circuit 88. The counter circuit 88 generates, under control of a horizontal scanning circuit 89, a 10-bit digital signal D0 into an output signal line 92.

The AD conversion operation for image signals that is performed in a thus-configured image sensor shall be described with reference to FIGS. 2A and 2B.

In a photodiode (not shown in FIG. 1) that is a photoelectric conversion element formed in the pixel circuit, electric charges are accumulated according to intensity of light radiated onto the photoelectric conversion element. At time T0, in the pixel circuit connected to a row in which the vertical scanning signal generated by the vertical scanning circuit 84 has become enable, the electric charges generated and accumulated in the photoelectric conversion element are converted into voltage, and applied to the column signal line as a signal voltage.

At the time, as FIG. 2A shows, a voltage 93 of the column signal line changes from a reset voltage Vr to a signal voltage Vs. At time T1 when the voltage 93 of the column signal line ends transition to become stable, the signal voltage that is an analog value is sampled in the S/H circuit 86, to be compared with a reference voltage in the comparator 87.

Meanwhile, the DAC 90 generates a ramp voltage 94 at which an output voltage rises from a ground voltage with time, and the ramp voltage 94 is applied to the reference voltage terminal of the comparator. The voltage 93 of the column signal line is repeatedly compared with the ramp voltage 94 rising from the ground voltage, and at time T3 when these voltages coincide with each other, a coincidence signal is generated.

The counter circuit 88 counts clock pulses during a period from time T2 at which the ramp voltage 94 applied by the DAC 90 starts rising until time T3 at which the coincidence signal is received, and the measured clock count is outputted as a digital value. In other words, as FIG. 2B shows, the value of the count, which is 000₍₁₆₎ (in hexadecimal, hereinafter the same) at time T2, increases by 1₍₁₆₎ per clock pulse. The counter circuit 88 counts up the value up to XYZ₍₁₆₎ at time T3 at which the coincidence signal is received from the comparator 87, and then stops the counting operation. Since the time at which the coincidence signal is generated by the comparator 87 varies, depending on the value Vs of the voltage 93 of the column signal line, the counter output that is a digital value also varies accordingly.

According to the conventional configuration described earlier, the accuracy according to the target resolution is required of the comparator 87. For example, assuming that the range of input voltage for the comparator 87 is 1 Vp−p, the fluctuation (rising) range of the ramp voltage 94 is also 1 V. When comparing these voltages at 10-bit resolution, the accuracy required of the comparator 87 is approximately 1 mV (=1 V/2¹⁰).

However, these days, along with the development of miniaturization in the semiconductor manufacturing process, accuracy is increasingly variable between comparators; therefore in order to satisfy the required accuracy, it is necessary to provide measures such as: providing a design that allows larger gate length or gate width of a transistor that is included in a comparator; or adding, to the comparator, a circuit that compensates for such variation of accuracy.

However, there is a problem that these measures increase the circuit area of the comparator and raise manufacturing costs. The higher the resolution becomes, and the higher the pixel density becomes, the more obvious the problem becomes.

### SUMMARY OF THE INVENTION

The present invention, conceived in view of such circumstances, has an object to provide a solid-state imaging device, a received-light intensity measuring device, and a received-light intensity measuring method that enable, by allowing variation in the accuracy of comparators, obtainment of a digital value according to an intensity of received light with higher resolution while suppressing the increase of the circuit area.

To achieve the above objective, the solid-state imaging device according to the present invention is a solid-state imaging device that obtains a digital value according to an intensity of light received by each of a plurality of pixels, and includes: a photoelectric conversion element that accumulates an amount of electric charges according to the intensity of light; an electric charge-voltage conversion unit that generates a signal voltage according to an amount of electric charges that are retained; a transfer switch that is connected to the photoelectric conversion element and the electric charge-voltage conversion unit, and that controls transfer of the electric charges accumulated in the photoelectric conversion element to the electric charge-voltage conversion unit; a control voltage applying unit that generates a control voltage that varies in a ramp waveform, and to apply the control voltage to a control terminal of the transfer switch; and a quantization unit that quantizes a length of time from a first point in time set with reference to a period during which the control voltage is applied to a second point in time at which a specific fluctuation occurs in a temporal variation rate of the signal voltage while the control voltage is being applied, to thereby obtain the digital value.

In addition, the quantization unit may quantize a length of time from the first point in time that is a point in time at which the signal voltage starts changing to the second point in time that is a point in time at which the signal voltage finishes changing.

To achieve this, the quantization unit may include: a differentiator that generates a derivative signal representing a differential value of the signal voltage; a comparator that compares the differential value represented in the derivative signal with a predetermined reference value; and a counting unit that counts clock pulses during a period from the first point in time to the second point in time, the period being a period in which a comparison signal indicating a predetermined result of the comparison is obtained from the comparator, to thereby obtain the digital value.

In addition, the quantization unit may quantize a length of time from the first point in time that is a point in time at which the control voltage starts changing to the second point in time that is a point in time at which the signal voltage either starts or finishes changing.

To achieve this, the quantization unit may include: a differentiator that generates a derivative signal representing a differential value of the signal voltage; a comparator that compares the differential value represented in the derivative signal with a predetermined reference value; and a counting unit that counts clock pulses during a period from the first point in time that is a leading edge of a command signal to the second point in time that is either a leading edge or a trailing edge of an output signal of the comparator, to thereby obtain the digital value, the command signal commanding the control voltage applying unit to generate the control voltage.

According to these configurations, the potential barrier in the region under the control terminal of the transfer switch gradually decreases along with the rise of the control voltage. Therefore, the electric charges accumulated in the photoelectric conversion element start to transfer to the electric charge-voltage conversion unit via the transfer switch, upon the control voltage reaching a particular voltage value. Subsequently, when all the electric charges accumulated in the photoelectric conversion element have completed the transfer to the electric charge-voltage conversion unit, the electric charge transfer finishes.

When the voltage signal is swept at a constant temporal variation rate, linearity is obtained between the amount of electric charges and the length of time. In addition, the temporal variation rate of the signal voltage is significantly different between the cases where the electric charges transfer through the transfer switch and where the electric charges do not transfer through the transfer switch; therefore, comparators that are variable in accuracy can detect the starting and ending points of the period of time.

Therefore, the digital value linearly corresponding to the received light can be obtained by quantizing the length of time, without having to use a comparator of high accuracy. Note that the resolution of the digital value is dependent on the temporal accuracy of detecting the length of time, and therefore it is important that the quantization unit including the comparator should be designed to operate with necessary temporal accuracy, instead of allowing variation of comparison accuracy in voltage, when obtainment of high resolution is intended.

The present invention can be realized not only as such a solid-state imaging device but also as a received-light measuring device and a received-light measuring method.

As described thus far, according to the solid-state imaging device of the present invention, the digital value linearly corresponding to the intensity of received light can be obtained by quantizing the length of time from a first point in time set with reference to a period during which the control voltage is applied to a second point in time at which a specific fluctuation occurs in a temporal variation rate of the signal voltage while the control voltage is being applied.

With this, since the resolution of the digital value is dependent on the temporal accuracy of detecting the length of time, it becomes possible to provide a solid-state imaging device, a received-light intensity measuring device, and a received-light intensity measuring method that enable, by allowing variation in the accuracy of comparators, obtainment of a digital value according to the intensity of the received light while suppressing increase of circuit area.

Further Information About Technical Background to this Application

The disclosure of Japanese Patent Application No. 2007-249909 filed on Sep. 26, 2007 including specification, drawings and claims is incorporated herein by reference in its entirety.

### BRIEF DESCRIPTION OF THE DRAWINGS

These and the other objects, advantages and features of the invention will become apparent from the following description thereof taken in conjunction with the accompanying drawings which illustrate a specific embodiment of the invention.

In the drawings:

FIG. 1 is a circuit configuration diagram of a conventional solid-state imaging device;

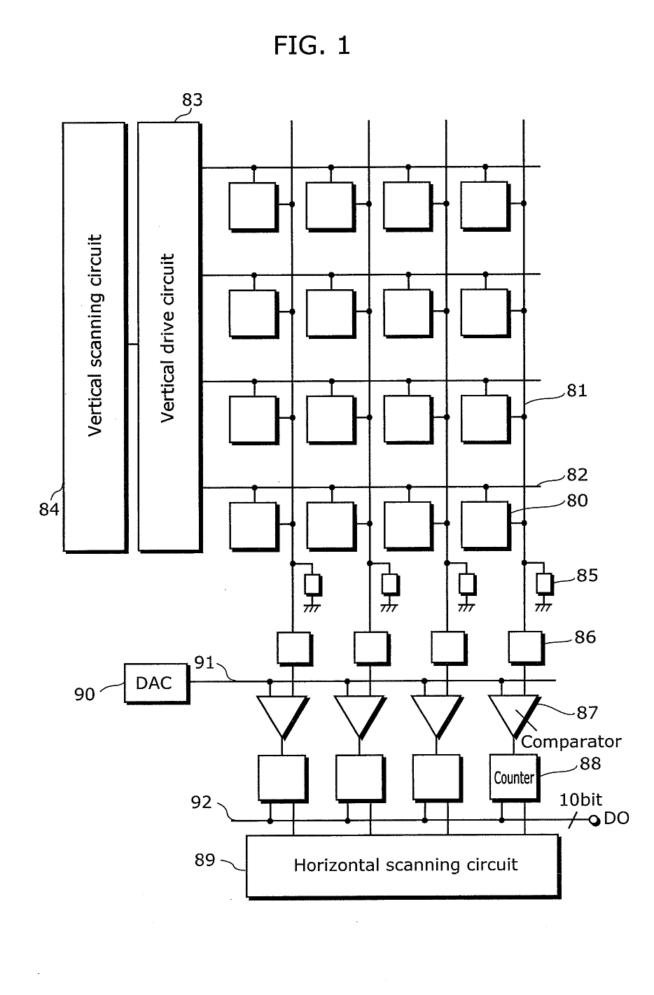

FIGS. 2A and 2B are read-operation timing diagrams of a conventional solid-state imaging device;

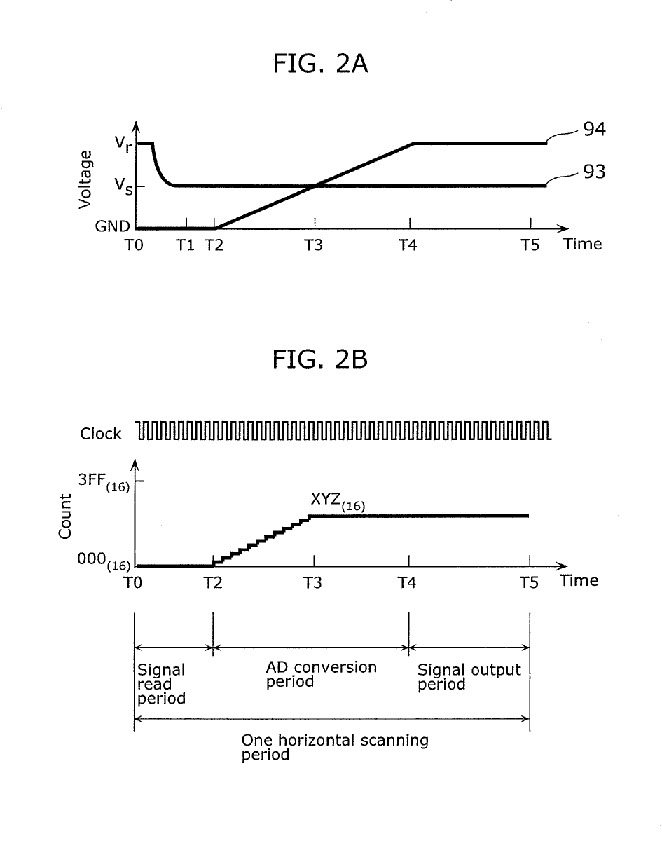

FIG. 3 is a circuit configuration diagram of a solid-state imaging device according to a first embodiment of the present invention;

FIG. 4 is a partial diagrammatic view of the circuit of the solid-state imaging device according to the first embodiment of the present invention;

FIG. 5 is a read-operation timing diagram of the solid-state imaging device according to the first embodiment of the present invention;

FIG. 6 is a pixel potential phase diagram of the solid-state imaging device according to the first embodiment of the present invention;

FIG. 7 is a column-signal-line voltage chart of the solid-state imaging device according to the first embodiment of the present invention;

FIG. 8 shows a relationship between a gate drive voltage range in which electric charge transfer occurs from a photodiode (PD) and light intensity, in a solid-state imaging device according to the first embodiment of the present invention;

FIG. 9 is a circuit configuration diagram of a solid-state imaging device according to a second embodiment of the present invention;

FIG. 10 is a partial diagrammatic view of the circuit of the solid-state imaging device according to the second embodiment of the present invention;

FIG. 11 is a read-operation timing diagram of the solid-state imaging device according to the second embodiment of the present invention;

FIG. 12 shows a relationship between a gate drive voltage at which electric charge transfer from the PD finishes and light intensity, in a solid-state imaging device according to the second embodiment of the present invention;

FIG. 13 is a partial diagrammatic view of a circuit of a solid-state imaging device according to a third embodiment of the present invention; and

FIG. 14 is a read-operation timing diagram of the solid-state imaging device according to the third embodiment of the present invention.

### DESCRIPTION OF THE PREFERRED EMBODIMENTS

### First Embodiment

A solid-state imaging device incorporating an AD-conversion function according to a first embodiment of the present invention shall be described with reference to the drawings.

The solid-state imaging device of the present embodiment applies a ramp voltage to a transfer switch control terminal, which controls electric charge transfer from a photodiode (PD) to a floating diffusion (FD) (specifically, the gate of a field-effect transistor), and quantizes a length of time from a point in time at which electric charges accumulated in the PD start to transfer until a point in time at which the transfer finishes, to thereby obtain a digital value for the amount of the accumulated electric charges.

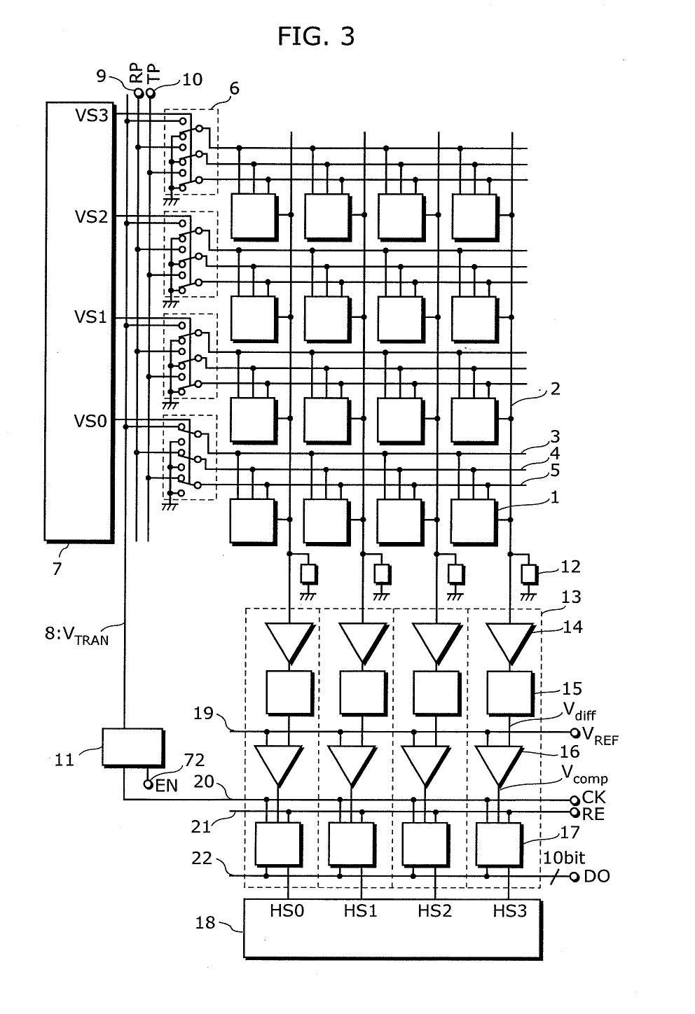

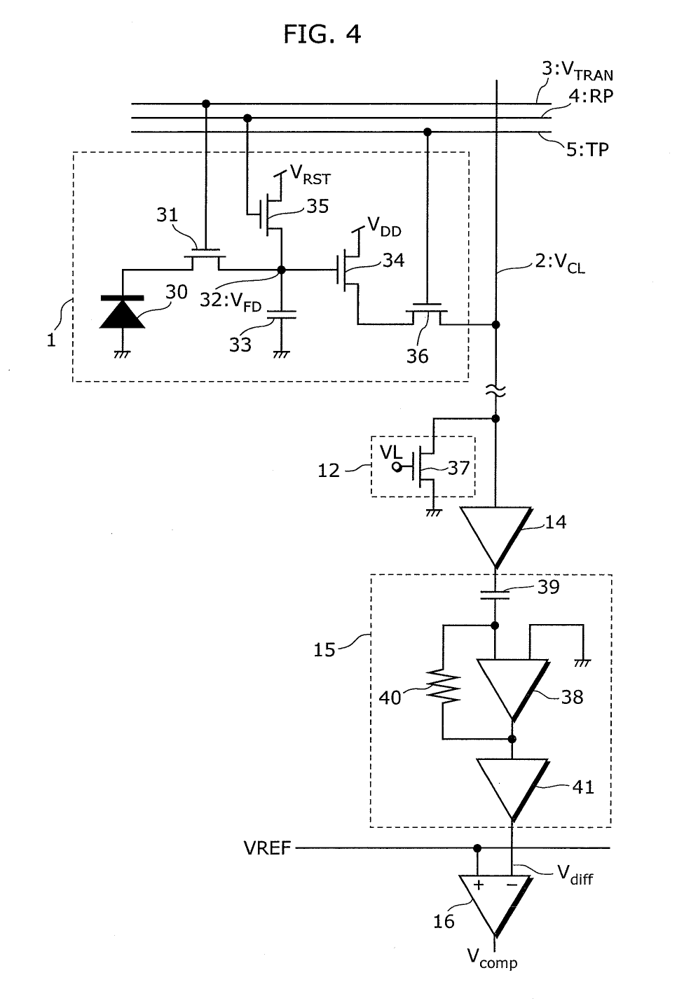

FIG. 3 is a circuit configuration diagram of the solid-state imaging device in the present embodiment, and FIG. 4 shows a portion thereof in detail.

In FIG. 3, pixel circuits 1 are arranged in a matrix, and a column signal line 2, a transfer control line 3, a row reset line 4, and a row select line 5 are connected to each of the pixel circuits.

The transfer control line 3, the row reset line 4, and the row select line 5 have one end connected, respectively, to: a transfer control signal line 8, a pixel reset signal (RP) line 9, and a switch 6 for switching between a pixel select signal (TP) line 10 and the grounding line according to a vertical scanning signal (VSn) generated by a vertical scanning circuit 7. To the transfer control signal line 8, the output of a digital-analog converter (DAC) 11 is connected, and the pixel reset signal line 9 and the pixel select signal line 10 lead to external input terminals.

The column signal line 2 has one end connected to the grounding line through a load resistor 12, and also to a column AD conversion circuit 13. The column AD conversion circuit 13 includes: an amplifier 14, a differentiator 15, a comparator 16, and a counter circuit 17. An output from the amplifier 14 to which the signal of the column signal line 2 is provided and the reference voltage V_{REF} from the reference voltage (V_{REF}) line 19 are applied to the comparator 16 via the differentiator 15. The output signal of the comparator 16 is connected to the counter circuit 17.

The counter circuit 17 and the DAC 11 are both connected to a clock (CK) line 20, and the counter circuit 17 generates, under control of a horizontal scanning circuit 18, a 10-bit digital signal D0 to the output signal line 22. In addition, the counter circuit 17 is connected to a counter reset signal (RE) line 21.

As FIG. 4 shows, each of the pixel circuits 1 includes elements such as: a photodiode 30 that is a photoelectric conversion element, a transfer switch 31, a floating diffusion (FD) capacitor 33, a read transistor 34, a reset switch 35, and a selection switch 36.

The photodiode 30 has the anode connected to ground, and the cathode connected to an FD node 32 via the transfer switch 31. The FD capacitor 33 is formed between the FD node 32 and a substrate within a predetermined FD region, and the gate of the read transistor 34 and the source of the reset switch 35 are connected to the FD node 32.

The gate of the transfer switch 31 is connected to the transfer control line 3. The drain of the reset switch 35 is supplied with a reset voltage V_{RST}, and the gate of the reset switch 35 is connected to the row reset line 4. The source of the read transistor 34 is connected to the column signal line 2 via the selection switch 36, and the drain is supplied with a power supply voltage VDD.

The gate of the selection switch 36 is connected to the row select line 5. In addition, for the load resistor 12 connected to one end of the column signal line 2, a load transistor 37 is used that is set to appropriate channel resistance according to a gate voltage VL.

The differentiator 15 is configured to include: an operation amplifier 38 having the positive input terminal (+) connected to ground and the negative input terminal (−) connected to an input capacitor 39 having capacitance Ci; a feedback resistor 40 having resistance Rf connected between the negative input terminal and the positive input terminal; and an output amplifier 41.

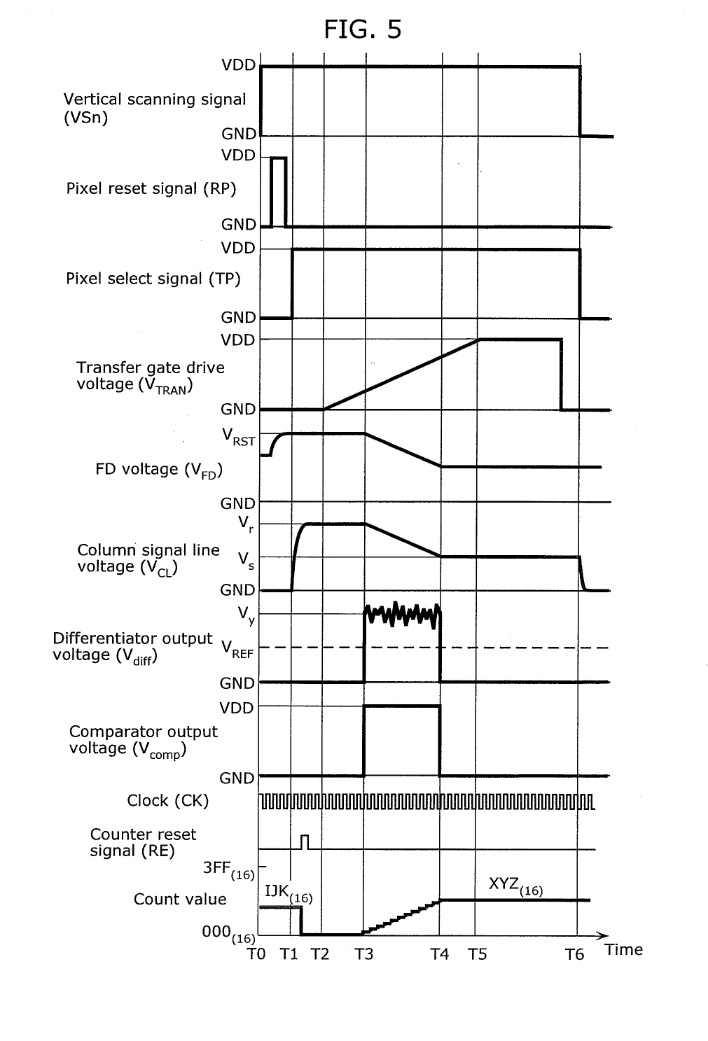

The read operation of the solid-state imaging device configured as above shall be described with reference to FIG. 5.

FIG. 5 is a graph showing temporal variations of major signals in the read operation at times from T0 to T6, which period corresponds to one horizontal scanning period.

FIG. 5 shows: the vertical scanning signal VSn generated by the vertical scanning circuit 7; the pixel reset signal RP applied from an external input terminal to the pixel reset signal line 9; a pixel select signal TP applied from an external input terminal to the pixel select signal line 10; a transfer gate drive voltage V_{TRAN} applied by the DAC 11 to the transfer control signal line 8; FD voltage V_{FD} of the FD node 32 in the pixel circuit; voltage V_{CL} on the column signal line 2; an output voltage V_{diff} from the differentiator 15; an output voltage V_{comp} from the comparator 16; a clock CK applied to the counter circuit 17 and the DAC 11; the counter reset signal RE applied to the counter circuit 17; and the count value in the counter circuit 17 represented in hexadecimal.

At time T0, the vertical scanning circuit 7 turns the switch 6 of the row to be read, from the grounding line over to the transfer control signal line 8, the pixel reset signal line 9, and the pixel select signal line 10, by providing to the row to be read, the vertical scanning signal VSn corresponding to one horizontal scanning period. FIG. 3 shows, as an example, the status of the switch 6 in the case where the vertical scanning signal VS0 is provided, assuming that the bottom row is to be read.

In the condition, by applying the pixel reset signal RP and turning the reset switch 35 ON, the FD voltage V_{FD} of the FD node 32 is reset to the reset voltage V_{RST}.

At time T1, by applying the pixel select signal TP and turning the selection switch 36 ON, the read transistor 34 and the column signal line 2 are connected to each other. At the time, the column signal line voltage V_{CL}, which is at the ground voltage, rises to a voltage Vr that is determined by the channel resistance of the read transistor 34 and the channel resistance of the load transistor 37.

At time T2, when an enable signal EN is provided to an enable signal (EN) terminal 72 of the DAC 11, the DAC 11 generates a ramp voltage rising from the ground voltage to the power supply voltage, as the transfer gate drive voltage V_{TRAN}. Here, it is preferable that the DAC 11 includes a low-pass filter in the output so that the transfer gate drive voltage V_{TRAN} rises smoothly. With the transfer gate drive voltage V_{TRAN}, which is the generated ramp voltage, being applied to the gate of the transfer switch 31, the transfer switch 31 gradually shifts from the OFF status to the ON status.

At time T3, the potential of the under-gate region of the transfer switch 31 coincides with the energy of electric charges (electrons) accumulated in the photodiode 30, and the accumulated electric charges start flowing into the FD node 32. The electric charges that have flown in are converted into a voltage at the FD capacitor 33 (and the gate of the read transistor 34 having parasitic capacitance), and the FD voltage V_{FD} starts decreasing.

Since the channel resistance of the read transistor 34 increases in response to the decrease in the FD voltage V_{FD}, the column signal line voltage V_{CL} also starts decreasing. The change in the column signal line voltage V_{CL} is transmitted through the amplifier 14 to the differentiator 15, and a differentiator output voltage V_{diff} rises from the ground voltage to a voltage V_{y}.

The electric charges continue to transfer from the photodiode 30 into the FD node 32 in response to the rise of the gate drive voltage V_{TRAN}, and both of the FD voltage V_{FD} and the column signal line voltage V_{CL} continue decreasing at a near-constant rate.

At time T4, when all the electric charges accumulated in the photodiode 30 are transferred to the FD node 32, the FD voltage V_{FD} stops decreasing, and the column signal line voltage V_{CL} stops decreasing at the same time. Since the column signal line voltage V_{CL} stops decreasing, the differentiator output voltage V_{diff} returns to the ground voltage.

Subsequently, until time T5, the gate drive voltage V_{TRAN} from the DAC 11 continues increasing, whereas the column signal line voltage V_{CL} maintains a given level of voltage Vs, and the differentiator output voltage V_{diff} remains the ground voltage.

The reference voltage V_{REF} to be applied to the comparator 16 is set between the ground voltage that is a differentiator output voltage V_{diff} at a Lo level and the voltage V_{y} that is a differentiator output voltage V_{diff} at a Hi level, and during a period from time T3 until time T4 when the differentiator output voltage V_{diff} is higher than the reference V_{REF}, the comparator 16 applies to the counter circuit 17, a comparator output voltage V_{comp} of a power supply voltage VDD (Hi) level.

The counter circuit 17, previously initialized to 000₍₁₆₎ by the counter reset signal RE being given, performs the counting operation in synchronization with the clock CK during a period in which the comparator output voltage V_{comp} at the Hi level is given by the comparator 16.

At time T4, when the differentiator output voltage V_{diff} becomes lower than the reference voltage V_{REF}, the comparator output voltage V_{comp} becomes the ground voltage, and the counter circuit 17 stops the counting operation. At the time, the count value XYZ₍₁₆₎ is a digital value of the electric charges generated and accumulated in the pixel circuit.

At time T5, the gate drive voltage V_{TRAN} from the DAC 11 reaches the power supply voltage VDD, to stop rising. The digital signal value of each column is provided to the output signal line 22 as a 10-bit digital signal D0 through control of the horizontal scanning circuit 18, during a period from time T5 at which the gate drive voltage V_{TRAN} stops rising to level off until time T6.

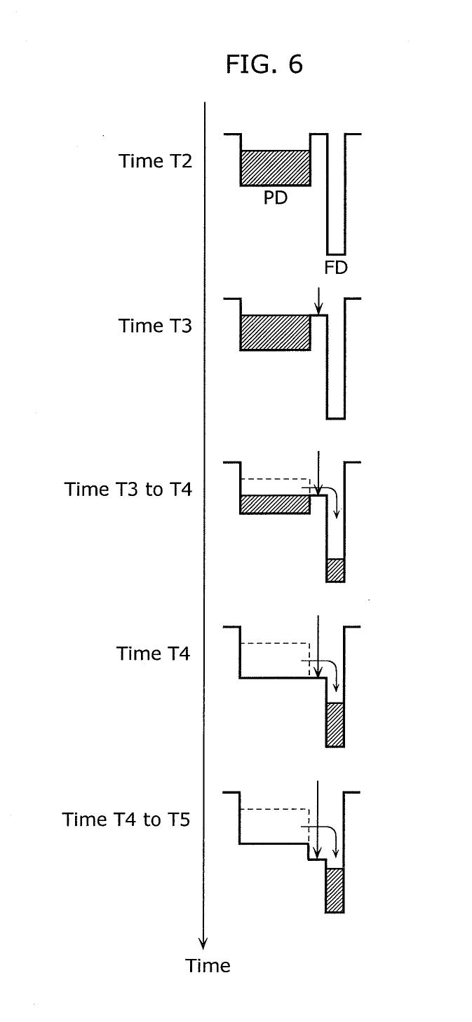

FIG. 6 is a diagram describing, at different points in time, the status of the potential and the electric charges in the main portion of the pixel circuit in the above-described read operation.

During a period from the start of the reading until time T2, the energy of the electric charges (electrons) accumulated in the PD (photodiode 30 in FIG. 4) is lower than the level of the potential of a TR (the under-gate region of the transfer switch 31 in FIG. 4), with the TR acting as a potential barrier.

After time T2, the potential of the TR decreases along with the rise of the gate drive voltage V_{TRAN} and reaches the same level as the energy of the electric charges at time T3, and the electric charges start to transfer to the FD (the FD capacitor 33 in FIG. 4).

After time T3, while the gate drive voltage V_{TRAN} is rising, the electric charges continue to transfer from the PD to the FD, and stop the transfer at time T4 when all the electric charges have completed the transfer.

Thus, the amount of the electric charges having transferred to the FD capacitor 33 and so on is detected, as described earlier, as the value of the column signal line voltage V_{CL} of the column signal line 2.

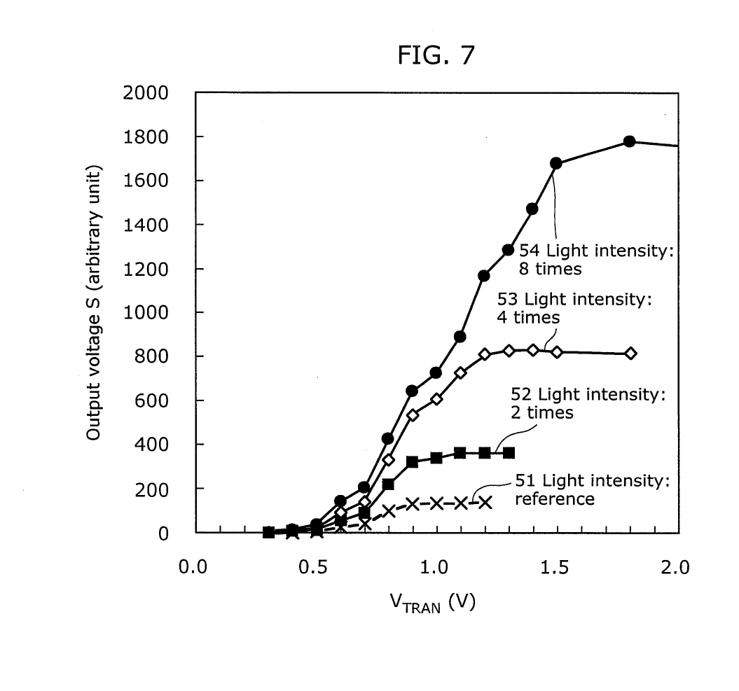

FIG. 7 is a graph showing the measurement result of the column signal line voltage V_{CL} of the column signal line 2, which varies along with the rise of the gate drive voltage V_{TRAN}. Here, instead of directly measuring the column signal line voltage V_{CL}, an output voltage S is measured by amplifying the column signal line voltage V_{CL}, using an inverting amplifier connected to the column signal line 2. The graphs from 51 to 54 represent the output voltage S measured when the intensity of the light radiated to the photodiode is increased by 2 times, 4 times, and 8 times, respectively, from a reference level of the intensity.

The saturation value of the output voltage S increases in proportion to light intensity, showing that the amount of the electric charges generated and accumulated in the photodiode is proportional to light intensity.

In addition, along with the increase in light intensity, the range in which output voltage S varies in proportion to the rise of the gate drive voltage V_{TRAN} becomes larger. In each of the light intensities, the difference between the gate drive voltage at which the output voltage S starts to increase and the gate drive voltage at which the output voltage S reaches saturation (stops increasing to level off) is calculated as ΔV_{TRAN}.

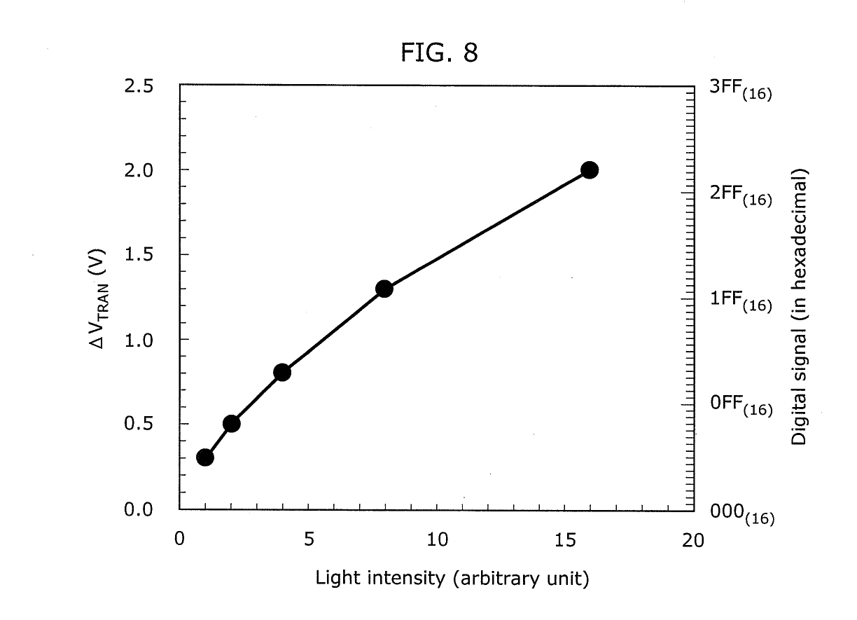

FIG. 8 is a graph showing the relationship between ΔV_{TRAN} and light intensity. The graph clarifies that the relationship between ΔV_{TRAN} and light intensity is nearly linear.

In the present embodiment, since the gate drive voltage V_{TRAN} is increased at a constant speed against time, the length of time for which the column signal line voltage varies (corresponding to T4−T3 in FIG. 5) becomes proportional to light intensity. Therefore, for the intensity of the light received by the photodiode 30, a digital signal having high linearity as shown in the right Y-axis in FIG. 8 can be obtained.

Next, as a specific exemplary design for implementing the above-described operation, drive timing and circuit parameter preferable for a VGA progressive-scanning solid-state imaging device shall be described.

Here, it is assumed that: one horizontal scanning period (corresponding to a period from T0 to T5 in FIG. 5) is 33.3 μs (=(1 s/60 frames/500 scanning lines); effective pixel count is horizontal 640×vertical 480; pixel count is horizontal 660×vertical 500; and power supply voltage VDD=3 V.

The AD conversion operation starts at time T2=2.7 μs in consideration of the time required for the input of the pixel reset signal RP and the pixel select signal TP and for the voltage stabilization of each node. Assuming that the clock frequency for driving the DAC 11 and the counter circuit 17 is 55 MHz, the time required for a 10-bit AD conversion is 18.6 μs (=2¹⁰/55 MHz), and the AD conversion finishing time is T5=21.3 μs.

Assuming the clock frequency as 55 MHZ, in common, for driving the horizontal scanning circuit 18 in the digital signal output operation after completion of the AD conversion, the time required for the digital signals to be outputted from all the columns is 12.0 μs (=660/55 MHz). In addition, the ascent rate dV_{TRAN}/dt of the transfer gate drive voltage V_{TRAN} during the AD-conversion period is:

1.6×10⁵ V/s(=VDD/(T5−T2)=3 V/18.6 μs).

It is assumed that: the maximum amount of electric charges (amount of saturated electric charges) accumulatable in the photodiode 30 of a pixel circuit 1 is n=5000 electrons; and the total capacitance (of the FD capacitor 33 and the gate capacitance of the read transistor 34) that are connected to the FD node 32 is CFD=2 fF. When all the saturated electric charges having been accumulated transfer to the FD capacitor 33 and the gate of the read transistor 34 having parasitic capacitance, the amount of variation ΔV_{FD} of the FD voltage from the reset voltage V_{RST} is: −0.4 V (=−n·e/C_{FD}=−5000×1.6×10⁻¹⁹/(2×10⁻¹⁵), with e representing an elementary electric charge amount).

In addition, the potential distribution for the under-gate region of the transfer switch 31, the photodiode 30, and the FD node 32 is designed such that: the gate drive voltage at which the electric charges start to transfer from the photodiode 30 into the FD node 32 becomes V_{TRAN}=0.5 V, and the gate drive voltage at which the electric charges finish the transfer becomes V_{TRAN}=2.5 V. At the time, the variation rate dV_{FD}/dt of the FD voltage due to the electric charge transfer from the photodiode 30 to the FD node 32 is: −3.2×10⁴ V/S (=(ΔV_{FD}/ΔV_{TRAN})×(dV_{TRAN}/dt)=(−0.4 V/(2.5 V−0.5 V))×(1.6×10⁵)).

In the electric-charge read operation, the read transistor 34 in the pixel circuit 1 and the load transistor 37 make up a source follower that is series connected through the selection switch 36, and the gain thereof is: Gi=0.85. In addition, the gain of the amplifier 14 connected to one end of the column signal line 2 is: G2=30. Accordingly, the variation speed of the voltage at the input terminal of the differentiator 15 is: dVi/dt=G1×G2×(dV_{FD}/dt)=−8.2×10⁵ V/S.

The input capacitance Ci connected to the operation amplifier 38 and the feedback resistance Rf are selected so that the product of them becomes 9×10⁻⁹. The output voltage of the operation amplifier 38 in this circuit parameter is 7.4 mV (=−Ci×Rf×(dVi/dt)), and is amplified to 220 mV by the output amplifier 41 having a gain G3=30. An output voltage of the output amplifier 41 is the differentiator output voltage V_{comp}. The differentiator output voltage V_{comp} is compared to the reference voltage V_{REF}=120 mV in the comparator 16.

Therefore, according to whether or not the column signal line voltage V_{CL} varies, a voltage difference of 120 mV is estimated between the ground voltage that is the differentiator output voltage V_{comp} at the Lo level and the reference voltage V_{REF}, and a voltage difference of 100 mv is estimated between the voltage V_{y}=220 mV that is the differentiator output voltage V_{comp} at the Hi level and the reference voltage V_{REF}.

These voltage differences are sufficiently larger than the accuracy that is conventionally required (for example, as described earlier, 1 mV when comparing voltages within the range of 1 V, using 10-bit resolution), thus allowing the use of a microfabricated transistor in design. Note that a design having hysteresis included in the input-output characteristics of the comparator 16 can further extend voltage margins.

### Second Embodiment

A solid-state imaging device incorporating an AD-conversion function according to a second embodiment of the present invention shall be described with reference to the drawings.

The solid-state imaging device of the present embodiment quantizes, assuming, as a reference time, the time at which a ramp voltage applied to the gate of a transfer switch starts rising, a length of time up to the time at which electric charges accumulated in a PD finish a transfer to an FD, to thereby obtain a digital value for an amount of accumulated electric charges.

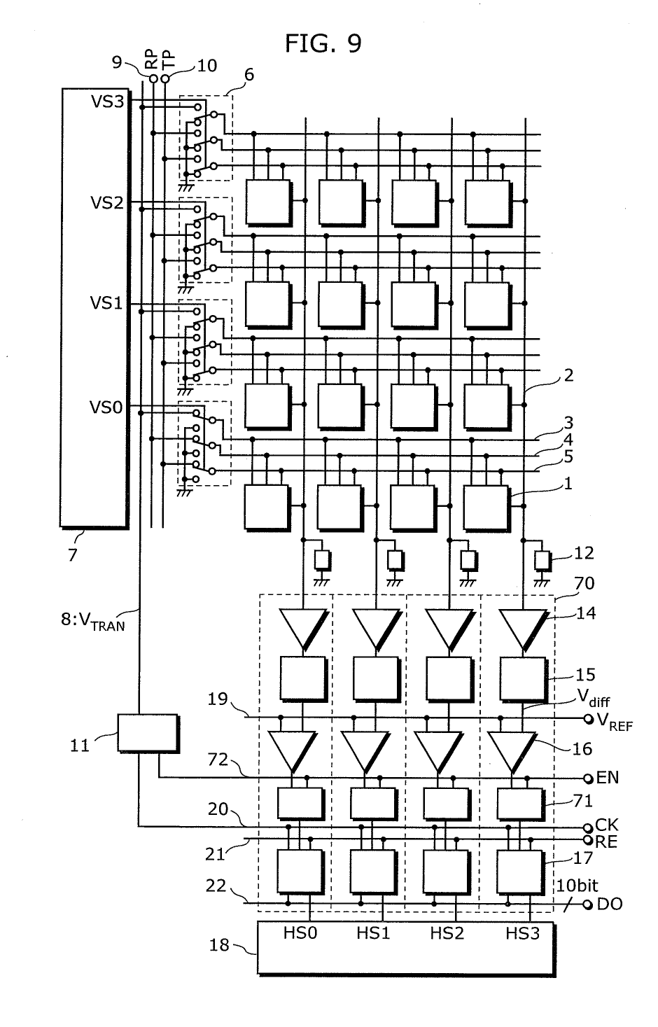

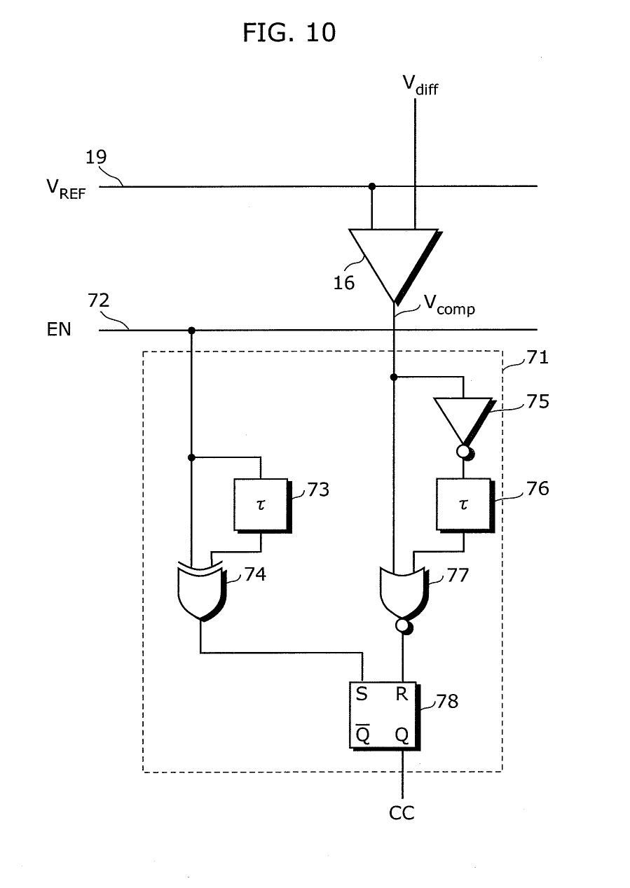

FIG. 9 is a circuit configuration diagram of a solid-state imaging device in the second embodiment of the present invention, and FIG. 10 is a circuit configuration diagram showing a portion thereof in detail. In FIG. 9, the arrangement of pixel circuits 1, and a row circuit made up of a transfer control line 3, a row reset line 4, and a row select line 5 are the same as in the first embodiment, and what is characteristic is a column AD conversion circuit 70.

The column AD conversion circuit 70 includes: an amplifier 14, a differentiator 15, a comparator 16, a counter control circuit 71, and a counter circuit 17.

As FIG. 10 shows, the counter control circuit 71, which is newly added to the first embodiment, is connected to the Enable signal (EN) terminal 72 that is shared with the DAC 11. The enable signal EN provided to the EN terminal 72 and a signal obtained by passing the enable signal EN through the delay circuit 73 are provided to an exclusive OR (XOR) circuit 74. In addition, an output signal from the comparator 16 in the preceding stage, and a signal obtained by passing the output signal through an inverter 75 and a delay circuit 76 are provided to a negative-OR (NOR) circuit 77. The outputs of the XOR circuit 74 and the NOR circuit 77 are provided, respectively, to a set (S) terminal and a reset (R) terminal of a SR latch in the subsequent stage.

The counter control circuit 71 thus configured generates a Hi-level counter control signal CC during a period from the leading edge of the enable signal EN to the trailing edge of the output signal of the comparator 16.

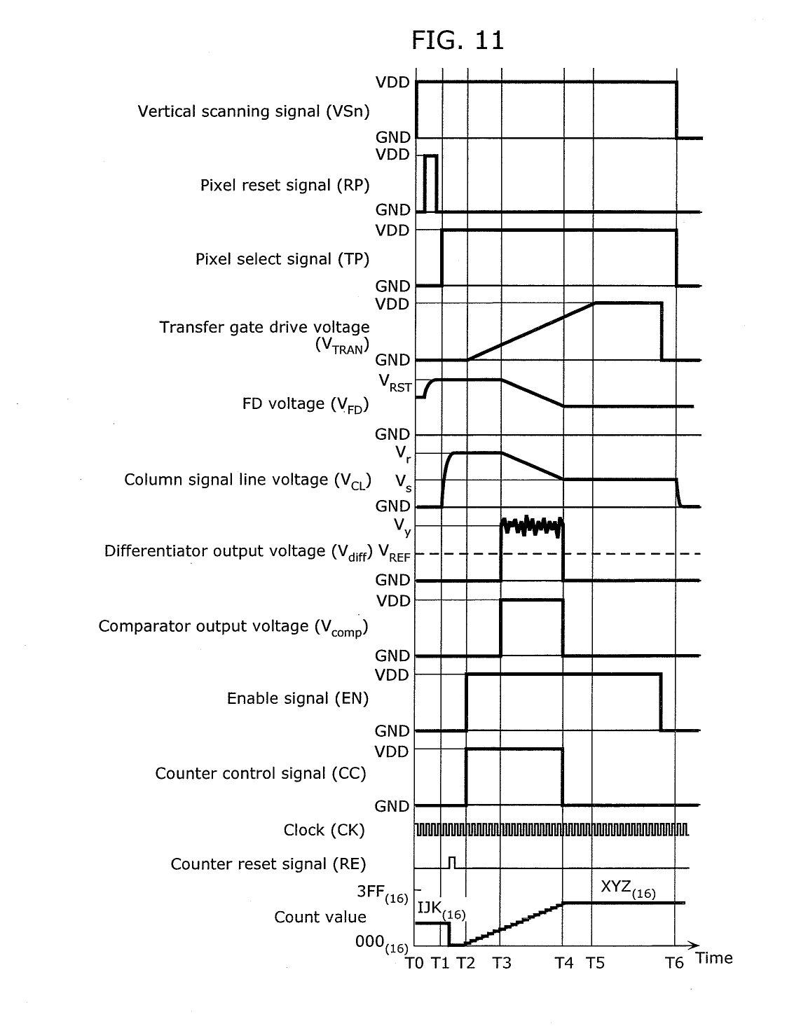

The read operation of the solid-state imaging device configured as above shall be described with reference to FIG. 11.

FIG. 11 is a graph showing temporal variations of major signals in the read operation according to times from T0 to T6, which period corresponds to one horizontal scanning period.

FIG. 11 illustrates: a vertical scanning signal VSn generated by the vertical scanning circuit 7; a pixel reset signal RP applied from an external input terminal to a pixel reset signal line 9; a pixel select signal TP applied from an external input terminal to a pixel select signal line 10; a transfer gate drive voltage V_{TRAN} applied by the DAC 11 to a transfer control signal line 8; the FD voltage V_{FD} of the FD node 32 in the pixel circuit; a voltage V_{CL} on a column signal line 2; an output voltage V_{diff} from the differentiator 15; an output voltage V_{comp} from the comparator 16; an Enable signal EN applied to the EN terminal 72; a counter control signal CC from the counter control circuit 71; a clock CK applied to the counter circuit 17 and the DAC 11; a counter reset signal RE applied to the counter circuit 17; and a count value at the counter circuit 17 represented in hexadecimal.

At time T0, the vertical scanning circuit 7 turns the switch 6 of the row to be read, from the grounding line over to the transfer control signal line 8, the pixel reset signal line 9, and the pixel select signal line 10, by providing, to the row to be read, the vertical scanning signal VSn in one horizontal scanning period. FIG. 3 shows, as an example, the status of the switch 6 when the vertical scanning signal VS0 is provided, assuming that the bottom row is to be read.

In the condition, by applying the pixel reset signal RP and turning the reset switch 35 ON, the FD voltage V_{FD} of the FD node 32 is reset to a reset voltage V_{RST}.

At time T1, by applying the pixel select signal TP and turning the selection switch 36 ON, a read transistor 34 and the column signal line 2 are connected to each other. At the time, the column signal line voltage V_{CL}, which is at the ground voltage, rises to a voltage Vr determined by the channel resistance of the read transistor 34 and the channel resistance of the load transistor 37.

At time T2, when providing an enable signal EN to an EN terminal 72 of the DAC 11, the DAC 11 generates, as the transfer gate drive voltage V_{TRAN}, a ramp voltage that rises from the ground voltage to the power supply voltage. Here, it is preferable that the DAC 11 includes a low-pass filter in the output so that the transfer gate drive voltage V_{TRAN} rises smoothly.

The counter control circuit 71 generates a Hi-level counter control signal CC in synchronization with the leading edge of the enable signal EN at time T2.

The counter circuit 17, previously initialized to 000₍₁₆₎ by the counter reset signal RE being given, starts the counting operation in synchronization with the clock CK, as a result of the input of the Hi-level counter control signal CC from the counter control circuit 71.

Concurrently, with the transfer gate drive voltage V_{TRAN}, which is a ramp voltage, being applied to the gate, the transfer switch 31 gradually shifts from the OFF status to the ON status.

At time T3, the potential of the under-gate region of the transfer switch 31 coincides with the energy of electric charges (electrons) accumulated in the photodiode 30, and the accumulated electric charges start flowing into the FD node 32. The electric charges that have flown in are converted into voltage at the FD capacitor 33 (and the gate of the read transistor 34 having parasitic capacitance), and the FD voltage V_{FD} starts decreasing.

Since the channel resistance of the read transistor 34 increases in response to the decrease in the FD voltage V_{FD}, the column signal line voltage V_{CL} also starts decreasing. The change in the column signal line voltage V_{CL} is transmitted through the amplifier 14 to the differentiator 15, and the differentiator output voltage V_{diff} rises from the ground voltage to voltage V_{y}.

The electric charges continue to transfer from the photodiode 30 into the FD node 32 in response to the rise of the gate drive voltage V_{TRAN}, and both of the FD voltage V_{FD} and the column signal line voltage V_{CL} continue decreasing at a near-constant rate.

At time T4, when all the electric charges accumulated in the photodiode 30 are transferred to the FD node 32, the FD voltage V_{FD} stops decreasing, and the column signal line voltage V_{CL} also stops decreasing. Since the column signal line voltage V_{CL} stops decreasing, the differentiator output voltage V_{diff} returns to the ground voltage.

Subsequently, until time T5, the gate drive voltage V_{TRAN} from the DAC 11 continues increasing, whereas the column signal line voltage V_{CL} maintains a given level of voltage Vs, and the differentiator output voltage V_{diff} remains the ground voltage.

The reference voltage V_{REF} to be applied to the comparator 16 is set between the ground voltage that is a differentiator output voltage V_{diff} at a Lo level and the voltage V_{y} that is a differentiator output voltage V_{diff} at a Hi level, and during a period from time T3 until time T4 when the differentiator output voltage V_{diff} is higher than the reference voltage V_{REF}, the comparator 16 applies to the counter control circuit 17, a comparator output voltage V_{comp} at a power supply voltage VDD (Hi) level.

At time T4, when the differentiator output voltage V_{diff} becomes lower than the reference voltage V_{REF}, the comparator output voltage V_{comp} becomes the ground voltage, and the counter control signal CC from the counter control circuit 71 reaches the Lo level in synchronization with the trailing edge of the comparator output voltage V_{comp}, so that the counter circuit 17 stops the counting operation. The count value XYZ₍₁₆₎ at the time is a digital value of the electric charges generated and accumulated in the pixel circuit.

At time T5, the gate drive voltage V_{TRAN} from the DAC 11 reaches the power supply voltage VDD, to stop rising. The digital signal value of each column is provided to the output signal line 22 as a 10-bit digital signal D0 through control of the horizontal scanning circuit 18, during a period from time T5 at which the gate drive voltage V_{TRAN} stops rising to level off until time T6.

As with the first embodiment, an output voltage S is measured by amplifying the column signal line voltage V_{CL}, using an inverting amplifier connected to the column signal line 2. In the second embodiment, in terms of various light intensities, the gate drive voltage V_{TRAN} is obtained at a time when the electric charges accumulated in the photodiode 30 finish the transfer to the FD capacitor 33, that is, at the time when the output voltage S starts rising.

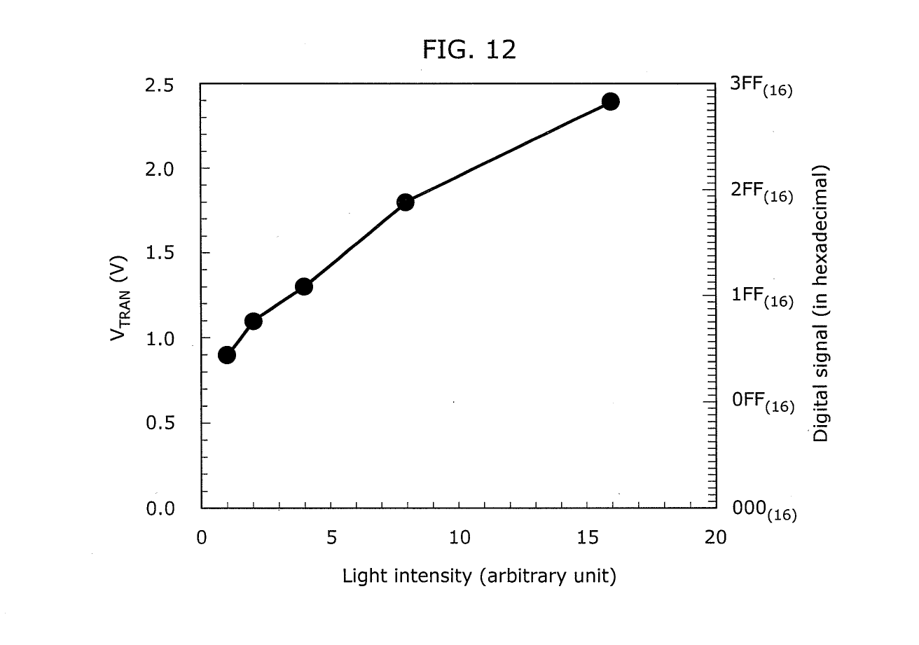

FIG. 12 is a graph showing the relationship between the gate drive voltage V_{TRAN} and light intensity when the output voltage S stops rising. The graph clarifies that the relationship between V_{TRAN} and light intensity is nearly linear.

In the present embodiment, since the gate drive voltage V_{TRAN} is increased at a constant speed against time, the length of time from when the gate drive voltage V_{TRAN} starts rising to when the column signal line voltage V_{CL} finishes changing (corresponding to T4−T2 in FIG. 11) also has a linear relationship to light intensity. Therefore, for the intensity of the light received by the photodiode 30, a digital signal having high linearity as shown in the right Y-axis in FIG. 12 can be obtained.

Note that in the present embodiment, for simplification, a method has been described for obtaining a digital value of the accumulated electric charges by quantizing the length of time from when the gate drive voltage V_{TRAN} starts rising to when the column signal line voltage V_{CL} finishes changing.

However, the starting point of the time to be quantized may precede the time at which the electric charges start to transfer from the photodiode 30 to the FD capacitor 33, that is, at an arbitrary time prior to the time at which the gate drive voltage V_{TRAN} starts rising. This is because the length of time from the starting point to the time at which the column signal line voltage V_{CL} finishes changing also has a linear relationship to light intensity.

### Third Embodiment

A solid-state imaging device incorporating an AD-conversion function according to a third embodiment of the present invention shall be described with reference to the drawings.

The solid-state imaging device of the present embodiment quantizes a length of time from the time at which a ramp voltage applied to the gate of a transfer switch starts rising to the time at which electric charges start to transfer from a photodiode 30 to an FD capacitor 33 (corresponding to T3−T2 in FIG. 11), to thereby obtain a digital value for an amount of accumulated electric charges.

A counter control circuit 71a in the solid-state imaging device in the present embodiment is modified, from the earlier-described counter control circuit 71, so as to generate a Hi-level counter control signal CC during a period from the leading edge of the enable signal EN to the leading edge of the output signal of the comparator 16.

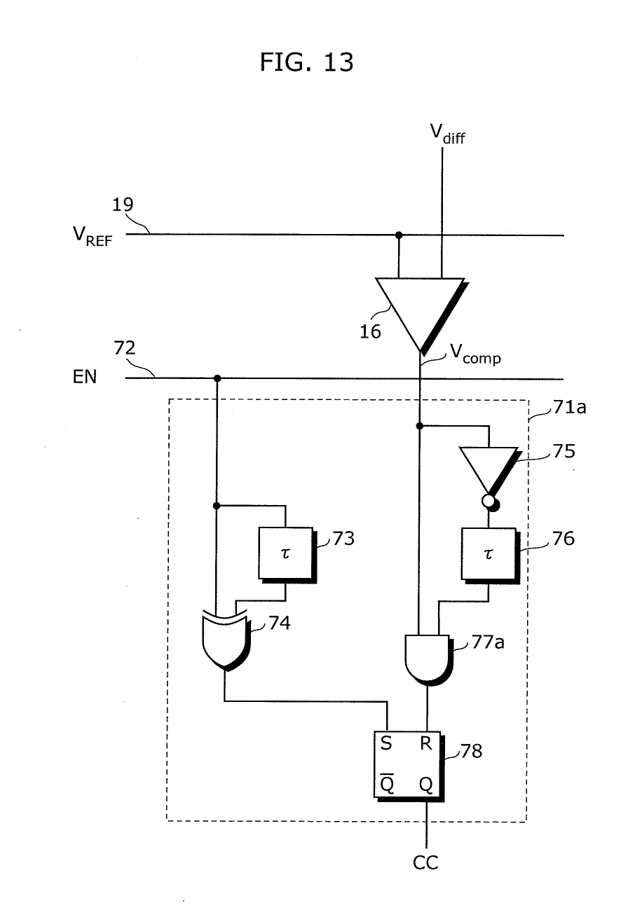

As FIG. 13 shows, the counter control circuit 71a is configured, in comparison with the counter control circuit 71 in the second embodiment (see FIG. 10), such that the negative-OR (NOR) circuit 77 is replaced with an AND circuit 77a.

The counter control circuit 71a thus configured generates a Hi-level counter control signal CC during a period from the leading edge of the enable signal EN to the leading edge of the output signal of the comparator 16.

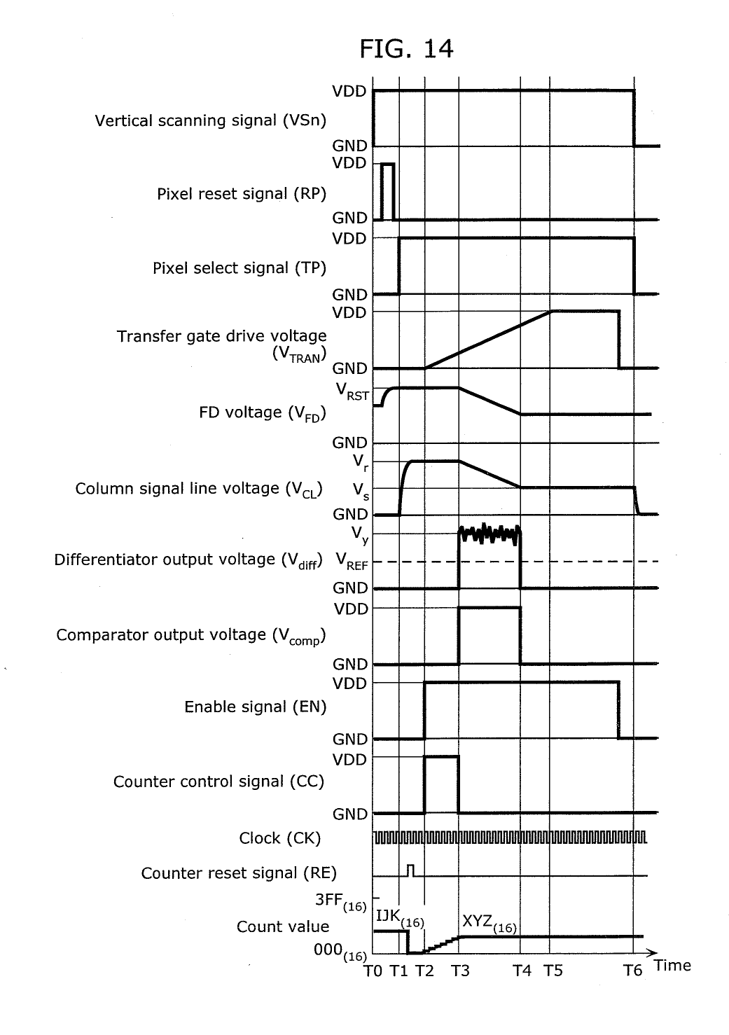

The read operation of the solid-state imaging device configured as above shall be described with reference to FIG. 14.

FIG. 14 is a graph showing temporal variations of major signals in the read operation according to times from T0 to T6, which period corresponds to one horizontal scanning period. The graph in FIG. 14 represents the same signals as in the graphs described earlier in FIG. 11.

Until time T3, the same operation proceeds as the operation described with reference to the graphs in FIG. 11.

The counter control circuit 71a generates a Hi-level counter control signal CC in synchronization with the leading edge of the enable signal EN at time T2.

At time T3, the potential of the under-gate region of the transfer switch 31 coincides with the energy of electric charges (electrons) accumulated in the photodiode 30, and the accumulated electric charges start flowing into the FD node 32. The electric charges that have flown in are converted into a voltage at the FD capacitor 33 (and the gate of the read transistor 34 having parasitic capacitance), and the FD voltage V_{FD} starts decreasing.

The column signal line voltage V_{CL} also starts decreasing in response to the decrease in the FD voltage V_{FD}, which causes the differentiator output voltage V_{diff} to rise from the ground voltage to the voltage V_{y}. The rising of the differentiator output voltage V_{diff} causes the counter control signal CC from the counter control circuit 71a to reach the Lo level, and the counter circuit 17 stops the counting operation.

The count value XYZ₍₁₆₎ at the time corresponds to the difference between the maximum amount of electric charges accumulatable in the photodiode 30 and the amount of electric charges that are actually generated and accumulated (that is, light intensity). Here, note that the larger the light intensity is, and therefore the larger the energy of the electric charges actually generated and accumulated is, the earlier the accumulated electric charges start to transfer into the FD node 32; thus, the count value XYZ₍₁₆₎ to be obtained becomes smaller.

According to the solid-state imaging device thus configured, it becomes possible to reduce the time required of the counter circuit 17 for performing the counting, from (T4−T2) to (T3−T2), although the light intensity dependence of the gate drive voltage V_{comp} at which the electric charges accumulated in the photodiode start transfer to the FD node 32 is smaller than the light intensity dependence of the gate drive voltage V_{comp} at which the accumulated electric charges finish the transfer. As a result, a high-speed AD conversion becomes possible by more or less sacrificing the dynamic range.

Such a high-speed AD conversion, when enabled, is useful in its application to a solid-state imaging device having characteristics such as high-density pixels, multiple tones, and high frame rates.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The solid-state imaging device according to the present invention can be utilized as a solid-state imaging device that generates a video signal as a digital value, and particularly is highly useful in various digital apparatuses in ubiquitous society as a technology for obtaining high resolution while suppressing the increase of circuit area.

What is claimed is:

1. A solid-state imaging device that obtains a digital value according to an intensity of light received by each of a plurality of pixels, said solid-state imaging device comprising:
a photoelectric conversion element that accumulates an amount of electric charges according to the intensity of light;
an electric charge-voltage conversion unit configured to generate a signal voltage according to an amount of electric charges that are retained;
a transfer switch that is connected to said photoelectric conversion element and said electric charge-voltage conversion unit, and that controls transfer of the electric charges accumulated in said photoelectric conversion element to said electric charge-voltage conversion unit;
a control voltage applying unit configured to generate a control voltage that varies in a ramp waveform, and to apply the control voltage to a control terminal of said transfer switch; and
a quantization unit configured to quantize a length of time from a first point in time set with reference to a period during which the control voltage is applied to a second point in time at which a specific fluctuation occurs in a temporal variation rate of the signal voltage while the control voltage is being applied, to thereby obtain the digital value.

2. The solid-state imaging device according to claim 1,
wherein said quantization unit is configured to quantize a length of time from the first point in time that is a point in time at which the signal voltage starts changing to the second point in time that is a point in time at which the signal voltage finishes changing.

3. The solid-state imaging device according to claim 2,
wherein said quantization unit includes:
a differentiator configured to generate a derivative signal representing a differential value of the signal voltage;
a comparator configured to compare the differential value represented in the derivative signal with a predetermined reference value; and
a counting unit configured to count clock pulses during a period from the first point in time to the second point in time, the period being a period in which a comparison signal indicating a predetermined result of the comparison is obtained from said comparator, to thereby obtain the digital value.

4. The solid-state imaging device according to claim 1,
wherein said quantization unit is configured to quantize a length of time from the first point in time that is a point in time at which the control voltage starts changing to the second point in time that is a point in time at which the signal voltage either starts or finishes changing.

5. The solid-state imaging device according to claim 4,
wherein said quantization unit includes:
a differentiator configured to generate a derivative signal representing a differential value of the signal voltage;
a comparator configured to compare the differential value represented in the derivative signal with a predetermined reference value; and
a counting unit configured to count clock pulses during a period from the first point in time that is a leading edge of a command signal to the second point in time that is either a leading edge or a trailing edge of an output signal of said comparator, to thereby obtain the digital value, the command signal commanding said control voltage applying unit to generate the control voltage.

6. A received-light intensity measuring device that obtains a digital value according to an intensity of received light, said received-light intensity measuring device comprising:
a photoelectric conversion element that accumulates an amount of electric charges according to the intensity of received light;
an electric charge-voltage conversion unit configured to generate a signal voltage according to an amount of electric charges that are retained;
a transfer switch that is connected to said photoelectric conversion element and said electric charge-voltage conversion unit, and that controls transfer of the electric charges accumulated in said photoelectric conversion element to said electric charge-voltage conversion unit;
a control voltage applying unit configured to generate a control voltage that varies in a ramp waveform, and to apply the control voltage to a control terminal of said transfer switch; and
a quantization unit configured to quantize a length of time from a first point in time set with reference to a period during which the control voltage is applied to a second point in time at which a specific fluctuation occurs in a temporal variation rate of the signal voltage while the control voltage is being applied, to thereby obtain the digital value.

7. A received-light intensity measuring method for obtaining a digital value according to an intensity of received light, comprising:
accumulating an amount of electric charges according to the intensity of received light;
applying a control voltage that varies in a ramp waveform, to a control terminal of a transfer switch that controls transfer of the accumulated electric charges;
converting an amount of electric charges into a voltage value while the control voltage is being applied, the electric charges having transferred through the transfer switch; and
measuring a length of time from a first point in time set with reference to a period during which the control voltage is applied to a second point in time at which a specific fluctuation occurs in a temporal variation rate of the voltage value, to thereby obtain the digital value.

8. The received-light intensity measuring method according to claim 7,
wherein said measuring includes:
obtaining a differential value of the voltage value;
comparing the differential value with a predetermined reference value; and
counting clock pulses during a period from the first point in time to the second point in time, the period being a period in which a predetermined result of the comparison is obtained in said comparing, to thereby measure the digital value.

9. The received-light intensity measuring method according to claim 7,
wherein said measuring includes:
obtaining a differential value of the voltage value;
comparing the differential value with a predetermined reference value; and
counting clock pulses during the first point in time that is a period from a leading edge of a command signal to the second point in time that is either a leading edge or a trailing edge of an output signal of the comparator, to thereby obtain the digital value, the command signal commanding the control voltage applying unit to generate the control voltage.
